(19) United States
(12) Patent Application Publication
(10) Pub. No.: US 2007/0147204 A1
(43) Pub. Date: Jun. 28, 2007

(54) Optical disk recording method and optical disk recording and reading apparatus

(76) Inventor: Artisune Nagamura, Kanagawa (JP)

Correspondence Address: DICKSTEIN SHAPIRO LLP, 1825 EYE STREET NW, Washington, DC, 20006-5403, US

(21) Appl. No.: 10/580,235

(22) PCT Filed: Sep. 26, 2005
(86) PCT No.: PCT/JP05/18209

§ 371 Date: May 23, 2006

(30) Foreign Application Priority Data
Sep. 30, 2004 (JP) 2004-287825

(51) Int. Cl. G11B 19/00

(52) U.S. Cl. 369/47.38

(57) ABSTRACT

An optical disk recording method wherein a beam is irradiated on an optical disk so that recording or write once of information is carried out, the optical disk recording method includes the step of controlling a recording velocity at the time of starting the write once, when the write once of information is carried out on the optical disk where the write once or rewriting can be carried out, the optical disk having a part where information is already recorded.

### TECHNICAL FIELD

The present invention relates to optical disk recording methods and optical disk recording and reading apparatuses, and more specifically, to an optical disk recording method and an optical disk recording and reading apparatus whereby a beam is irradiated on an optical disk as a optical recording medium so that information is recorded and a write once of the information is carried out.

### BACKGROUND ART

Currently, as optical technology advances, an optical disk exclusively used for reading such as a Compact Disk (CD) for music or CD-ROM, a write once type optical disk (CD-R (Recordable) ) using dye-based medium, a rewritable optical disk (CD-RW (Rewritable)) using a phase change recording material, and others are realized. In addition, an optical disk having a mass capacity such as a Digital Versatile Disk (DVD), DVD-ROM, DVD+R (Recordable), or DVD+RW (Rewritable) becomes attractive as the wave length of a semiconductor laser (LD) as a laser light source is shortened, the spot diameter of a high NA objective lens is made small, or a thin type board of the optical disk is applied. In the field of the DVD+R, in the optical disk recording and reading apparatus corresponding to an initial DVD+R, a recording linear velocity of 2.4 times velocity and being constant (CLV: Constant Linear Velocity) is the main current. However, as technology advances and recording velocity increases, it is difficult to implement the CLV recording from an internal circumferential part to an external circumferential part at a constant 8 times, 12 times, or 16 times linear velocity due to physical limitation of the optical disk recording and reading apparatus.

Because of this, a method called a Zone-CLV method (Z-CLV) may be used. In this method, the optical disk is virtually divided into two or more zones and a recoding linear velocity is controlled for every zone. However, in order to efficiently record or reduce the consumption of electric power due to a change in the number of rotations, a Constant Angular Velocity (CAV) method wherein the angular velocity is constant or a Partial-CAV (P-CAV) method wherein the CLV and the CAV are properly combined may be more suitable or proper than the Z-CLV method.

However, in the case of the CAV recording method, while the number of the rotation is constant for any recording position on the optical disk, the recording velocity varies corresponding to the circumference of a part where writing (recording or write once) is carried out on the optical disk. Furthermore, the recording power of the laser for recording the information outgoing onto the recording surface of the optical disk from the optical pick up when the optical disk recording and reading apparatus is used generally becomes high corresponding to the recording velocity.

Because of this, it is general practice that the recording power at the time of CAV recording is controlled corresponding to the radial position at the time of recording by multiplying the power level obtained by an Optimum Power calibration (OPC) by a variable depending on the radial direction position. See Japan Laid-Open Patent Application Publication No, 2001-344751. In addition, a running OPC may be used during the writing operation. See Japan Laid-Open Patent Application Publication No. 2000-200416. In the running OPC, whether the present recording power is proper is, always or when a certain time passes, monitored during the writing operation so as to maintain a proper power level, that is, a write power control is implemented, in order to prevent the recording power from being offset from a most proper recording power due to a change of the property of the recording position of the optical disk or the influence of the property change during the recording by the optical disk recording and reading apparatus. Hence, in a case where a write once of information is carried out on the optical disk where information is recorded part of the way, it is not possible to implement a recording power correction by the running OPC at the time of starting the writing once. Generally, if the recording power is offset from the most proper value, the recording quality is degraded. If the recording power is degraded more than a certain level, a problem may occur at the time of reading.

In the conventional CD-R, a changing margin of recording power acceptable for maintaining a sufficiently high recording quality is relatively large. Hence, an offset of the recording power generated due to not implementing the correction by using the running OPC at the time of starting write once may not be a serious problem. However, the optical disk used for recording at a high density, such as a write once type DVD+R, as compared with the CD-R, has less changing margin of the recording power whereby a sufficient recording quality against the change of the recording power can be maintained. Because of this, recording power control at the time of starting the write once in a case where the write once is carried out on the CAV recording area is a problem. For example, Japan Laid-Open Patent Application Publication No. 2003-85759 discloses that the recording quality is maintained during a time period from the start of the write once to the start of the recording power correction by the running OPC by correctly controlling the power at the time of the write once.

In a case where a high speed recording is implemented on a high density optical disk such as a DVD+R, since the recording power margin is relatively less than that of the CD-R or the like, a sufficient recording quality may not be secured at the time of starting the write once by the technology disclosed in Japan Laid-Open Patent Application Publication No. 2003-85759.

### DISCLOSURE OF THE INVENTION

Accordingly, it is a general object of the present invention to provide a novel and useful optical disk recording method and optical disk recording and reading apparatus.

Another and more specific object of the present invention is to provide an optical disk recording method whereby the recording quality at a write once part is improved when a write once of information is carried out on the optical disk where information is recorded part of the way with a CAV type recording method, wherein the recording linear velocity is changed at internal and external circumference of the optical disk; and an optical disk recording and reading apparatus using the above-mentioned recording method.

The present invention is achieved by an optical disk recording method wherein a beam is irradiated on an optical disk so that recording or write once of information is carried out, the optical disk recording method including the step of controlling a recording velocity at the time of starting the write once, when the write once of information is carried out on the optical disk where the write once or rewriting can be carried out, the optical disk having a part where information is already recorded.

The present invention is also achieved by an optical disk recording and reading apparatus, including: a spindle motor configured to rotate an optical disk; a control part configured to control the spindle motor so that the optical disk is rotated by a Constant Angular Velocity (CAV) method or a Constant Linear Velocity (CLV) method; and an optical pick up configured to radiate a beam on the optical disk so that recording or write once of information is carried out; wherein the control part controls a recording velocity at the time of starting the write once, when the write once of information is carried out on the optical disk where the write once or rewriting can be carried out, the optical disk having a part where information is already recorded.

Other objects, features, and advantages of the present invention will become more apparent from the following detailed description when read in conjunction with the accompanying drawings.

### BRIEF DESCRIPTION OF THE DRAWINGS

FIG. 1 is a block diagram schematically showing a structure of an optical disk recording and reading apparatus of an embodiment of the present invention;

FIG. 2 is a graph showing a power margin whereby a recording quality high enough for a recording power can be maintained;

FIG. 3 is a view showing an operating principle of OPC;

FIG. 4 is s graph showing a comparison between a case where recording power correction by running OPC is made and a case where the recording power correction by the running OPC is not made;

FIG. 5 is a flowchart showing an example of a control process of recording control of the present invention;

FIG. 6 is a flowchart showing another example of a control process of recording control of the present invention; and

FIG. 7 is a flowchart showing a further other example of a control process of recording control of the present invention.

### BEST MODE FOR CARRYING OUT THE INVENTION

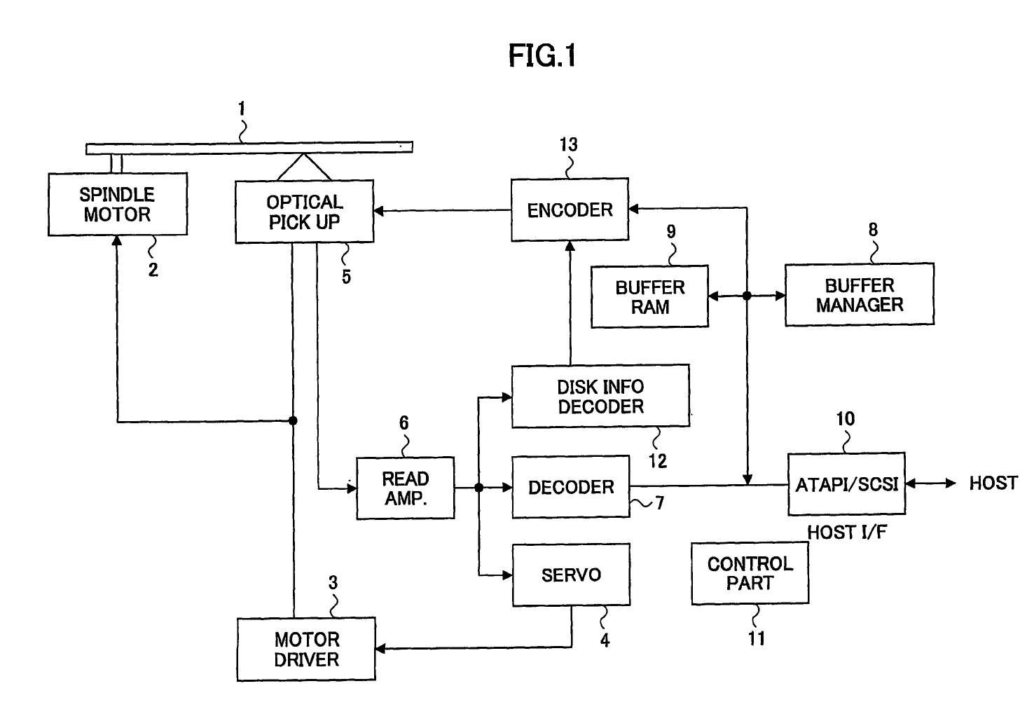

A description of the present invention and details of drawbacks of the related art are now given, with reference to FIG. 1 through FIG. 7, including embodiments of the present invention.

FIG. 1 is a block diagram schematically showing a structure of an optical disk recording and reading apparatus of an embodiment of the present invention. The optical disk recording and reading apparatus includes a spindle motor 2, a control part, and an optical pick up 5. The spindle motor 2 rotates an optical disk 1 The control part controls the spindle motor 2 so that the optical disk 1 is rotated by a CAV method or a CLV method. The optical pick up 5 radiates a beam to the optical disk 1 so that information is recorded or read, or a write once of the information is carried out. The optical disk 1 to which a write once or rewriting of data can be carried out, such as a DVD+R, DVD+RW, or the like is rotated by the spindle motor 2. The spindle motor 2, rotating the optical disk 1, is controlled so that the optical disk 1 is controlled by the CAV method or the CLV method by the motor driver 3 as the control part, the servo part 4, and a control part 11 controlling the motor driver 3 and the servo part 4.

As described above, the optical pick up 5 radiates a laser beam onto the optical disk 1 rotated by a driving part of the spindle motor 2 or the like so that the information is recorded or read, or a write once of the information is carried out. Although not shown in FIG. 1, the optical pick up 5 includes a laser light source, a collimation lens, an objective lens, an optical path separation element, an optical detector, an actuator, or the like. The laser light source (laser diode, for example) radiates a laser light. The collimation lens changes an outgoing beam from the laser light source to a substantially parallel light (or a weak divergent light or convergent light). The beam from the collimation lens is focused on a recording surface of the optical disk 1 by the objective lens. The optical path separation element separates the beam, reflected by the recording surface of the optical disk 1, so as to pass through the objective lens (or the objective lens and the collimation lens) in a reverse direction from the light path of the irradiation light. As the optical path separation element, a polarization separation element such as a polarization diffraction grating, a polarization hologram a polarization beam splitter, or the like, can be used. Such an optical path separation element can be used by combining a ¼ wave length plate or the like. The optical detector consists of plural or multi-segment light receiving elements. The optical detector receives a reflection beam from the optical disk 1 that is separated by the light path separation element so as to detect the focus servo signal, the track servo signal, and an information signal (RF signal). The actuator drives the objective lens in the focus direction or the track direction. The optical pick up 5 is supported by a moving mechanism whereby the optical pick up 5 is moved in a radial direction of the optical disk 1.

The optical pickup 5 emanates a laser beam from a laser source. The laser beam is focused on the recording surface of the optical disk 1 by an objective lens. The laser beam reflected by a recording surface of the optical disk 1 is received by the optical detector. An output signal of this optical detector is transmitted to a control part 11 of a control system so that a focus servo signal, a track servo signal, or the like is detected. The actuator is controlled by each of the servo parts 4 of the focus servo and the track servo based on the detected focus servo signal and the track servo signal, so that the focus servo and the track servo are performed. As a result of this, the data recorded in the optical disk 1 are read so that the reading signal is obtained, or the data are recorded or a write once of the data is carried out.

When reading the data, the read signal (RF signal) obtained by the optical pickup 5 is amplified and digitized in a read amplifier 6, after which de-interleaving and error correction are performed in a decoder 7. The output data from the decoder 7 are temporarily stored in a buffer RAM 9 by a buffer manager 8 and when the data are collected up as sector data, they are transferred to a host (host computer: personal computer) via a host interface (host I/F (ATAPI/SCSI interface)) 10.

In contrast, when recording data, the data transmitted from the host via the host I/F 10 are temporarily stored in the buffer RAM 9 by the buffer manager 8 so as to be sent to an encoder 13 and thereby data recording is started. Before beginning the data recording, Optimum Power Calibration (OPC) is performed in a trial recording area referred to as a Power Calibration Area (PCA) and an optimum recording power is obtained. The control of recording velocity for the optical disk 1 is realized by controlling the spindle motor 2 or the optical pick up 5 by the control part 11.

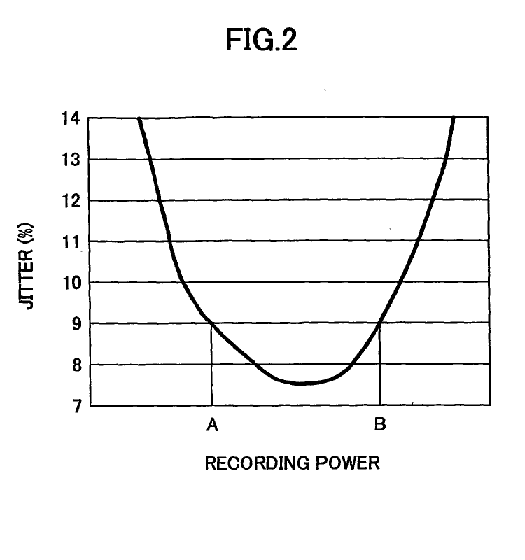

FIG. 2 shows an example showing a change of jitter that has an influence to a recording quality when recording power is changed. The recording power when the jitter is the minimum is generally a most proper power. It has been determined that recording quality is sufficiently high if the jitter is less than 9%. Therefore, it is possible to record on the optical disk 1 with a sufficiently high recording quality by controlling the recording power of a laser beam outgoing from the optical pick up 5 between a recording power A and a recording power B of FIG. 2. The difference between the recording power A and the recording power B is called a recording power margin. The larger the recording power margin, the larger the permissible amount of offset from the most proper value of the recording power during recording. The amount of the recording power margin is varied based on plural elements such as the characteristics of the optical disk 1 to be used, a recording strategy, and the characteristics of the optical pick up 5.

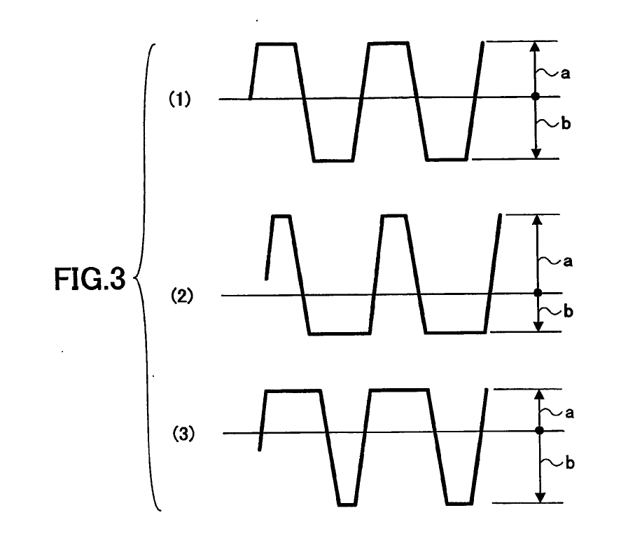

In a write once type optical disk such as DVD+R, power is often controlled by using a parameter called “β” or a parameter similar to this “β”. “β” is a parameter showing too much or little power by a characteristics of an RF signal. A β value detecting part eliminates a low component of the RF signal (AC coupling) and detects an upper side envelope line level a and a lower side envelope line level b. The explanation about this is discussed with reference to FIG. 3. As a property of a recording film of the write once type optical disk, it is assumed that the reflection rate at the recording mark part becomes low and the RF signal at the low reflection part becomes a low level.

In a case of a proper recording state, as shown in (1) of FIG. 3, the RF signal that is AC coupled is up-and-down symmetric and “a” is equal to “b”. In a case where the recording power is too high, as shown in (2) of FIG. 3, a recording mark part becomes long and therefore if the AC coupling is done, the upper side level “a” becomes high so that “a” is greater than “b”. In a case where the recording power is too low, as shown in (3) of FIG. 3, the recording mark part becomes short and therefore if the AC coupling is done, the lower side level “b” becomes high so that “a” may be less than “b”.

The difference between “a” and “b” is normalized by an RF amplitude ‘^{Λ}a+b” so that “β” is obtained. That is,
β=(a−b)/(a+b)

Generally, in a case where writing is carried out on the write once type optical disk 1 having a consistent property, if β is large, the recording power is often too high. If/? is small, the recording power is often too low. Thus, control of the laser output power can be done according to the RF signal property detected by the optical disk recording and reading apparatus.

Generally, when recording is started on the optical disk 1 such as DVD+R, Optimum Power Control (OPC) is implemented in a drive test area in a PCA area of an internal or external circumferential part of the optical disk. The Optimum Power Control (OPC) is an operation whereby power is changed in multiple steps so that trial writing is carried out so that a most proper power is determined.

On the other hand, a method wherein a predetermined recording state objective value and a value corresponding to a reproducing signal from a recording medium are compared so that recording power is corrected based on the result of the comparison during writing information, is suggested. This method is called a running OPC because the power correction is done full time during recording while the trail writing is called OPC.

Next, specific examples of the present invention are discussed.

### FIRST EXAMPLE

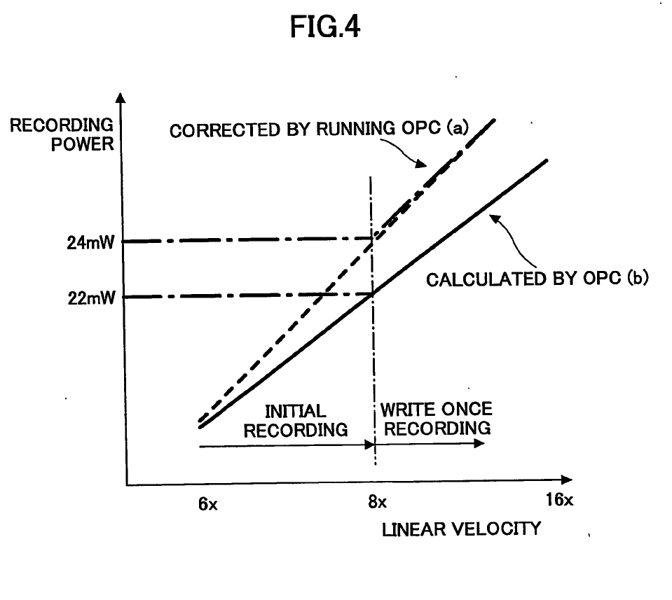

FIG. 4 is a graph schematically showing a relationship between the recording power and the recording linear velocity as an example of a CAV recording. The vertical axis of the graph represents the recording power and the horizontal axis of the graph represents the linear velocity. This graph shows a change of the recording power in a case where recording is started at internal circumference 6× (six times velocity) and is stopped at internal circumference 8× (eight times velocity) and then the write once is performed at that position. A lower side tilted solid line (b) represents a recording power level calculated corresponding to the linear velocity based on a result of the OPC at the internal circumference part 6× (six times velocity). An upper side tilted dotted line (a) represents a recording power when the correction is continued by the running OPC. Although the recording power is increased linearly due to the increase of the recording linear velocity in the example shown in FIG. 4, the present invention can be applied regardless of the linearity.

When writing is stopped at the recording linear velocity 8× (eight times velocity), the recording power corrected by the running OPC is 24 mW. The recording power calculated by only the result of the OPC is 22 mW. There is a difference of 2 mW between them. Accordingly, if writing is started at the recording power 22 mW calculated from only the result of the OPC at the time of starting the write once, recording is done at an improper recording power because the recording power should be corrected by the running OPC. In this case, where the most proper recording power when the jitter becomes bottom in FIG. 2 is 24 mW, if the recording power A is larger than 22 mW, the power is not properly set due to non-implementation of the running OPC. Hence, a sufficiently high recording quality cannot be realized.

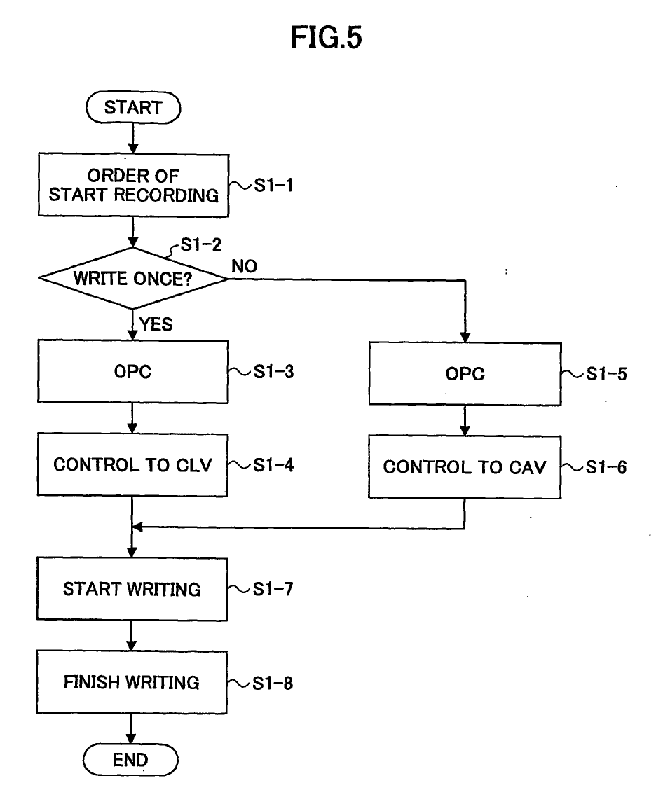

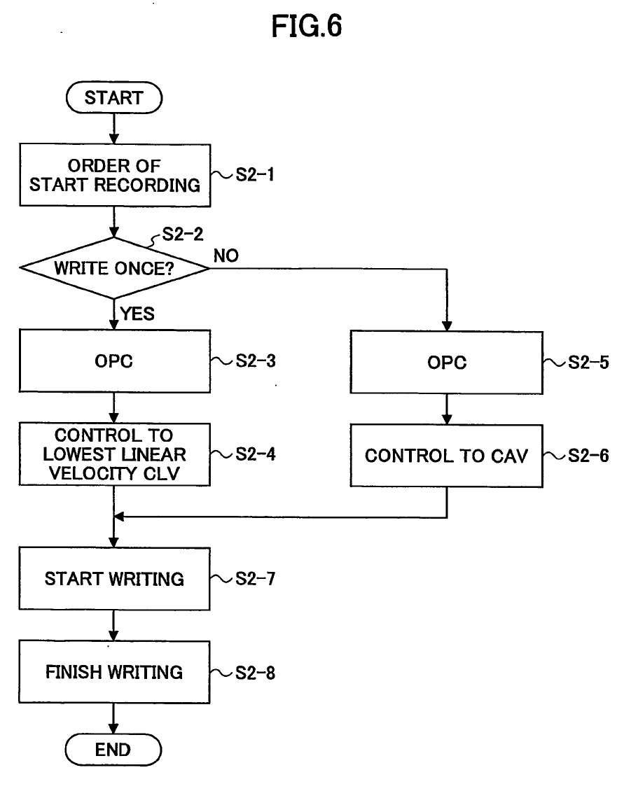

Hence, in the embodiment of the present invention, in a case where the write once is carried out, in order to prevent the degrading of the recording quality due to non-implementation of the power correction by the running OPC, when the write once is not carried out, the recording velocity is controlled by the combination of the optical disk recording and reading apparatus carrying out the CAV recording and the optical disk 1. When the write once is carried out, the recording velocity at the starting of the write once is controlled. An example of the control processes of the recording control is shown in flowcharts of FIG. 5 and FIG. 6.

Referring to FIG. 5, an order for the start of recording information is input from the host to the control part 11 of the optical disk recording and reading apparatus via the host I/F 10 shown in FIG. 1 (Sl-I). After that, the laser beam is irradiated on the recording surface of the optical disk 1 by the optical pick up 5 and the reflection light by the recording surface of the optical disk 1 is detected by the optical detector of the optical pick up S, so that the information of the optical disk 1 is read out by the control part 11. Next, whether information is already recorded on the optical disk 1 to be recorded so that recording at this time corresponds to the write once is determined based on the information of the optical disk read out by the control part 11 (Sl-2). In a case where it is determined that this recording corresponds to the write once, after the OPC is performed (Sl-3), the optical disk 1 is controlled by the CLV method using the recording linear velocity used for the OPC so that the spindle motor 2 is rotated (Sl-4) and thereby lack of the sufficient recording quality due to non-implementation of power correction by the running OPC at the time when the write once is started is prevented. In a case where the recording does not correspond to the write once, after the OPC is performed (Sl-5), the recording speed is controlled according to the CAV method at the time of normal recording, this being a case where the write once is not carried out, so that the spindle motor 2 is rotated (Sl-β). After that, writing (write once or recording) is started at the recording power determined by the OPC or a way similar to the OPC (Sl-7). If all of the information to be recorded is recorded, writing is completed (Sl-8).

Thus, when the write once is carried out on an optical disk where the write once or rewriting can be carried out, the optical disk having a part where information is already recorded, the recording velocity at the time of starting the write once is controlled. More specifically, the recording velocity at the time of starting the write once is controlled by the CLV method using a linear velocity the same as a recording velocity at the time when the OPC is carried out. Because of this, the write once is started at the recording power determined by the OPC. Therefore, it is possible to realize a high recording quality at the part where the write once is started.

Control processes of steps S2-1 through S2-3, S2-5 through S2-6, and S2-7 and S2-8 shown in FIG. 6 are substantially same as the steps Sl-1 through Sl-3, Sl-5 through Sl-6, and Sl-7 and Sl-8 shown in FIG. 5. In a case of an optical disk recording and reading apparatus wherein a lowest recording velocity is not the same as the recording linear velocity at the time of OPC, as step S2-4 shown in FIG. β, recording is carried out by controlling the recording linear velocity at the time of starting the write once at the CLV of the lowest recording linear velocity among plural recording linear velocities (2.4 times velocity, β times velocity, 8 times velocity, 12 times velocity, 16 times velocity, . . . ) by which the recording optical disk recording and reading apparatus supports the optical disk 1. Under this structure, it is possible to realize a high recording quality even at the time of staring the write once.

### SECOND EXAMPLE

Next, an example in a case where the position where the write once is started is close to the inner-most circumferential recording position is discussed.

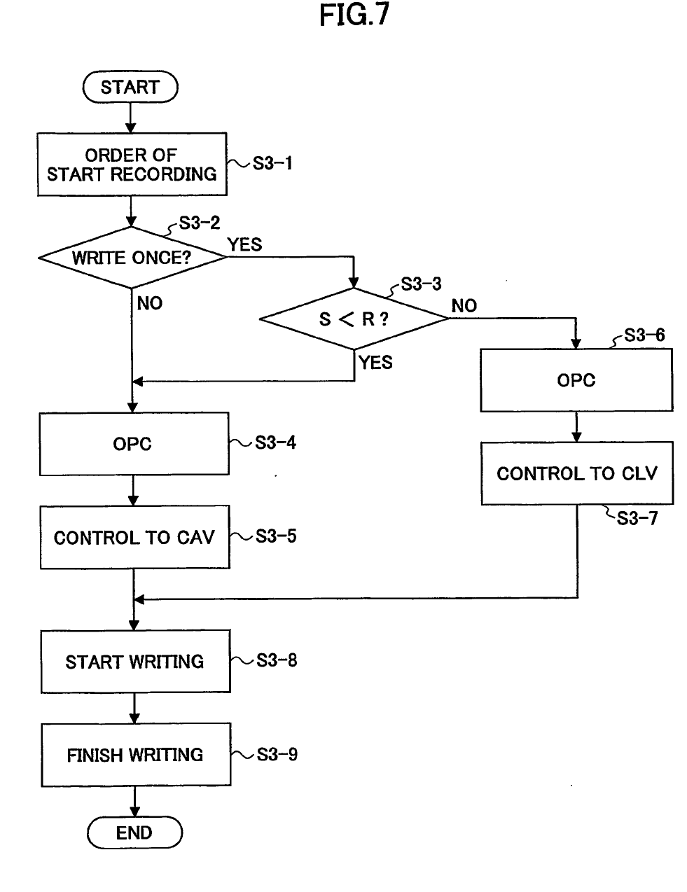

In a case where i) the recording velocity X at the time of staring the write once is defined by Y<X<(Y+(Z−Y)/2) wherein a lowest recording linear velocity corresponding to the optical disk is defined as Y and a highest recording linear velocity corresponding to the optical disk is defined as Z; and/or ii) S<R is satisfied at a part where the write once is started wherein a distance in a radial direction from a position where the recording is started at the internal circumferential part of the optical disk to a position where the write once is started is defined as S, a distance from a most internal circumferential recording starting position to a most external circumferential recording completion position is defined as T, and R being constant has a value less than T/2, as shown in FIG. 4, a difference between the recording power calculated by the OPC and a value corrected by the running OPC is small. Only in a case where this difference of the recording power can be sufficiently in the power margin (difference between the recording powers A and B) shown in FIG. 2, unlike in a case of the first example, recording is carried out in a state where the recording velocity at the start of the write once, for the purpose of reducing the time for writing, is made the same as the recording velocity when the write once is not carried out. An example of this control process is shown in a flowchart of FIG. 7.

Referring to FIG. 7, an order for start of recording information is input from the host to the control part 11 of the optical disk recording and reading apparatus via the host I/F 10 shown in FIG. 1 (S3-1). After that, the laser beam is irradiated on the recording surface of the optical disk 1 by the optical pick up 5 and the reflection light by the recording surface of the optical disk 1 is detected by the optical detector of the optical pick up 5, so that the information of the optical disk 1 is read out by the control part 11. Next, whether information is already recorded on the optical disk 1 to be recorded and recording at this time corresponds to the write once is determined based on the information of the optical disk read out by the control part 11 (S3-2). In a case where it is determined that recording corresponds to the write once, ‘the control part 11 determines whether the distance S from a position where the recording is started to a part where the write once is started is less than R (S3-3). If it is determined that S is less than R, after the OPC is performed (S3-4), the CAV method using the recording velocity at the time when the write once is started, the velocity being the same as the recording velocity when normal recording is carried out without carrying out the write once, so that the spindle motor 2 is rotated (S3-5). If it is determined that S is not less than R, after the OPC is performed (S3-6), the optical disk 1 is controlled by the CLV method using the recording linear velocity used for the OPC so that the spindle motor 2 is rotated (S3-7) and thereby lack of the sufficient recording quality due to non-implementation of the power correction by the running OPC at the time when the write once is started is prevented. In a case where the recording does not correspond to the write once at step S3-2, after the OPC is performed (S3-4), the recording speed is controlled by the CAV method at the time of normal recording in a case where the write once is not carried out, so that the spindle motor 2 is rotated (S3-5). After that, writing (write once or recording) is started by the recording power determined by the OPC or a way similar to the OPC (S3-8) If all of information to be recorded is recorded, writing is completed (S3-9) As discussed above, in a case where i) the recording velocity X at the time of starting the write once is defined by Y<X<(Y+(Z−Y)/2) wherein a lowest recording linear velocity corresponding to the optical disk is defined as Y and a highest recording linear velocity corresponding to the optical disk is defined as Z; and/or ii) S<R is satisfied at a part where the write once is started wherein a distance in a radial direction from a position where the recording is started at the internal circumferential part of the optical disk to a position where the write once is started is defined as S, a distance from a most internal circumferential recording starting position to a most external circumferential recording completion position is defined as T, and R being constant has a value less than T/2, it is possible to reduce the time for writing by controlling the recording velocity at the time when the write once is started so as to be the same as the recording velocity when the write once is not carried out.

Thus, in the above-discussed embodiment of the present invention, an optical disk recording method wherein a beam is irradiated on an optical disk so that recording or write once of information is carried out, the optical disk recording method including the step of controlling a recording velocity at the time of starting the write once, when the write once of information is carried out on the optical disk where the write once or rewriting can be carried out, the optical disk having a part where information is already recorded, is provided.

An optical disk recording and reading apparatus, including a spindle motor configured to rotate an optical disk; a control part configured to control the spindle motor so that the optical disk is rotated by a Constant Angular Velocity (CAV) method or a Constant Li-near Velocity (CLV) method; and an optical pick up configured to radiate a beam on the optical disk so that recording or write once of information is carried out; wherein the control part controls a recording velocity at the time of starting the write once, when the write once of information is carried out on the optical disk where the write once or rewriting can be carried out, the optical disk having a part where information is already recorded, is also provided.

According to the above-mentioned method or apparatus, it is possible to realize high recording quality without carrying out correction of the recording power by the running OPC.

In the optical disk recording method, recording may be carried out by a Constant Angular Velocity (CAV) method at the time of normal recording; and the recording velocity at the time of starting the write once may be controlled, at the time when the write once of information is carried out on the optical disk where the write once or rewriting can be carried out, the optical disk having both the part where information is already recorded and a part where information is physically not recorded.

In the optical disk recording and reading apparatus, recording may be carried out by the CAV method at the time of normal recording; and the control part may control the recording velocity at the time of starting the write once at the time when the write once of information is carried out on the optical disk where the write once or rewriting can be carried out, the optical disk having both the part where information is already recorded and a part where information is physically not recorded.

According to the above-mentioned method or apparatus, it is possible to realize high recording quality without carrying out correction of the recording power by the running OPC.

In the optical disk recording method, recording may be carried out by a Constant Angular Velocity (CAV) method at the time of normal recording; and a recording method at the time of starting the write once may be changed from the CAV method to a Constant Linear Velocity (CLV) method, at the time when the write once of information is carried out on the optical disk where the write once or rewriting can be carried out, the optical disk having both the part where information is already recorded and a part where information is physically not recorded.

In the optical disk recording and reading apparatus, recording may be carried out by the CAV method at the time of normal recording; and the control part may change a recording method at the time of starting the write once from the CAV method to the CLV method, at the time when the write once of information is carried out on the optical disk where the write once or rewriting can be carried out, the optical disk having both the part where information is already recorded and a part where information is physically not recorded.

According to the above-mentioned method or apparatus, it is possible to realize high recording quality without carrying out correction of the recording power by the running OPC.

In the optical disk recording method, recording may be carried out by the CLV method using a plurality of recording linear velocities; and the recording velocity at the time of starting the write once may be controlled by the CLV method using one of the recording linear velocities corresponding to the optical disk.

In the optical disk recording and reading apparatus, recording may be carried out by the CLV method using a plurality of recording linear velocities; and the control part may control the recording velocity at the time of starting the write once by the CLV method using one of the recording linear velocities corresponding to the optical disk.

According to the above-mentioned method or apparatus, it is possible to realize high recording quality without carrying out correction of the recording power by the running OPC.

In the optical disk recording method, the recording velocity at the time of staring the write once may be controlled by the CLV method using a linear velocity the same as the recording velocity at the time when an Optimum Power Calibration (OPC) is carried out at an internal or external circumferential part of the optical disk.

In the optical disk recording and reading apparatus, the control part may control the recording velocity at the time of starting the write once by the CLV method using a linear velocity the same as the recording velocity at the time when an Optimum Power Calibration (OPC) is carried out at an internal or external circumferential part of the optical disk.

According to the above-mentioned method or apparatus, since the write once can be started at a recording power determined by the OPC, it is possible to realize a high recording quality at the part where the write once is started.

In the optical disk recording method, the recording velocity at the time of starting the write once may be controlled by the CLV method using a lowest recording linear velocity among the recording linear velocities corresponding to the optical disk.

In the optical disk recording and reading apparatus, the control part may control the recording velocity at the time of starting the write once by the CLV method using a lowest recording linear velocity among the recording linear velocities corresponding to the optical disk.

According to the above-mentioned method or apparatus, it is possible to maintain high recording quality at the part where the write once is started.

In the optical disk recording method, the recording velocity X at the time of starting the write once may be defined by Y<X<(Y+(Z−Y)/2) in a case where a lowest recording linear velocity corresponding to the optical disk is defined as Y and a highest recording linear velocity corresponding to the optical disk is defined a.s Z; and a recording velocity may be controlled so as to be the same as the recording velocity when the write once is not carried out, in a case where the recording velocity at the time of staring the write once is equal to or the less than X.

In the optical disk recording and reading apparatus, the recording velocity X at the time of starting the write once may be defined by Y<X<(Y+(Z−Y)/2) in a case where a lowest recording linear velocity corresponding to the optical disk is defined as Y and a highest recording linear velocity corresponding to the optical disk is defined as Z; and a recording velocity may be controlled so as to be the same as the recording velocity when the write once is not carried out, in a case where the recording velocity at the time of starting the write once is equal to or the less than X.

According to the above-mentioned method or apparatus, it is possible to reduce a time for writing.

In the optical disk recording method, the recording velocity at the time of starting the write once may be controlled so as to be the same recording velocity as a recording velocity when the write once is not carried out, in a case of S<R at a part where the write once is started wherein a distance in a radial direction from a position where the recording is started at the internal circumferential part of the optical disk to a position where the write once is started is defined as S, a distance from a most internal circumferential recording starting position to a most external circumferential recording completion position is defined as T, and R being constant has a value less than T/2.

In the optical disk recording and reading apparatus, the recording velocity at the time of starting the write once may be controlled so as to be the same recording velocity as a recording velocity when the write once is not carried out, in a case of S<R at a part where the write once is started wherein a distance in a radial direction from a position where the recording is started at the internal circumferential part of the optical disk to a position where the write once is started is defined as S, a distance from a most internal circumferential recording starting position to a most external circumferential recording completion position is defined as T, and R being constant has a value less than T/2.

According to the above-mentioned method or apparatus, it is possible to reduce a time for writing.

Thus, according to the above-discussed embodiment of the present invention, an optical disk recording method whereby the recording quality at a write once part is improved when a write once of information carried out on the optical disk where information is recorded part of the way in a CAV type recoding method wherein a recording linear velocity is changed at internal and external circumference of the optical disk, and an optical disk recording and reading apparatus using the above-mentioned recording method can be realized. Accordingly, the present invention can be properly used for an optical disk recording and reading apparatus corresponding to a write once type or rewritable type optical disk such as CD-R, CD-RW, DVD+R, DVD+RW, or the like.

The present invention is not limited to the above-discussed embodiments, but variations and modifications may be made without departing from the scope of the present invention.

This patent application is based on Japanese Priority Patent Application No. 2004-287825 filed on Sep. 30, 2004, the entire contents of which are hereby incorporated by reference.

1. An optical disk recording method wherein a beam is irradiated on an optical disk so that recording or write once of information is carried out, the optical disk recording method comprising the step of:
controlling a recording velocity at the time of starting the write once, when the write once of information is carried out on the optical disk where the write once or rewriting can be carried out, the optical disk having a part where information is already recorded.

2. The optical disk recording method as claimed in claim 1,
wherein recording is carried out by a Constant Angular Velocity (CAV) method at the time of normal recording; and
the recording velocity at the time of starting the write once is controlled, at the time when the write once of information is carried out on the optical disk where the write once or rewriting can be carried out, the optical disk having both the part where information is already recorded and a part where information is physically not recorded.

3. The optical disk recording method as claimed in claim 1,
wherein recording is carried out by a Constant Angular Velocity (CAV) method at the time of normal recording; and
a recording method at the time of starting the write once is changed from the CAV method to a Constant Linear Velocity (CLV) method, at the time when the write once of information is carried out on the optical disk where the write once or rewriting can be carried out, the optical disk having both the part where information is already recorded and a part where information is physically not recorded.

4. The optical disk recording method as claimed in claim 3,
wherein recording is carried out by the CLV method using a plurality of recording linear velocities; and
the recording velocity at the time of starting the write once is controlled by the CLV method using one of the recording linear velocities corresponding to the optical disk.

5. The optical disk recording method as claimed in claim 4,
wherein the recording velocity at the time of staring the write once is controlled by the CLV method using a linear velocity the same as the recording velocity at the time when an Optimum Power Calibration (OPC) is carried out at an internal or external circumferential part of the optical disk.

6. The optical disk recording method as claimed in claim 4,
wherein the recording velocity at the time of starting the write once is controlled by the CLV method using a lowest recording linear velocity among the recording linear velocities corresponding to the optical disk.

7. The optical disk recording method as claimed in claim 5,
wherein the recording velocity X at the time of starting the write once is defined by Y<X<(Y+(Z−Y)/2) in a case where a lowest recording linear velocity corresponding to the optical disk is defined as Y and a highest recording linear velocity corresponding to the optical disk is defined as Z; and
a recording velocity is controlled so as to be the same as the recording velocity when the write once is not carried out, in a case where the recording velocity at the time of staring the write once is equal to or the less than X.

8. The optical disk recording method as claimed in claim 5,
wherein the recording velocity at the time of starting the write once is controlled so as to be the same recording velocity as a recording velocity when the write once is not carried out, in a case of S<R at a part where the write once is started wherein a distance in a radial direction from a position where the recording is started at the internal circumferential part of the optical disk to a position where the write once is started is defined as S, a distance from a most internal circumferential recording starting position to a most external circumferential recording completion position is defined as T, and R being constant has a value less than T/2.

9. An optical disk recording and reading apparatus, comprising:
a spindle motor configured to rotate an optical disk;
a control part configured to control the spindle motor so that the optical disk is rotated by a Constant Angular Velocity (CAV) method or a Constant Linear Velocity (CLV) method; and
an optical pick up configured to radiate a beam on the optical disk so that recording or write once of information is carried out;
wherein the control part controls a recording velocity at the time of starting the write once, when the write once of information is carried out on the optical disk where the write once or rewriting can be carried out, the optical disk having a part where information is already recorded.

10. The optical disk recording and reading apparatus as claimed in claim 9,
wherein recording is carried out by the CAV method at the time of normal recording; and
the control part controls the recording velocity at the time of starting the write once at the time when the write once of information is carried out on the optical disk where the write once or rewriting can be carried out, the optical disk having both the part where information is already recorded and a part where information is physically not recorded.

11. The optical disk recording and reading apparatus as claimed in claim 9,
wherein recording is carried out by the CAV method at the time of normal recording; and
the control part changes a recording method at the time of starting the write once from the CAV method to the CLV method, at the time when the write once of information is carried out on the optical disk where the write once or rewriting can be carried out, the optical disk having both the part where information is already recorded and a part where information is physically not recorded.

12. The optical disk recording and reading apparatus as claimed in claim 11,
wherein recording is carried out by the CLV method using a plurality of recording linear velocities; and
the control part controls the recording velocity at the time of starting the write once by the CLV method using one of the recording linear velocities corresponding to the optical disk.

13. The optical disk recording and reading apparatus as claimed in claim 12,
wherein the control part controls the recording velocity at the time of starting the write once by the CLV method using a linear velocity the same as the recording velocity at the time when an Optimum Power Calibration (OPC) is carried out at an internal or external circumferential part of the optical disk.

14. The optical disk recording and reading apparatus as claimed in claim 12,
wherein the control part controls the recording velocity at the time of starting the write once by the CLV method using a lowest recording linear velocity among the recording linear velocities corresponding to the optical disk.

15. The optical disk recording and reading apparatus as claimed in claim 13,
wherein the recording velocity X at the time of starting the write once is defined by Y<X<(Y+(Z−Y)/2) in a case where a lowest recording linear velocity corresponding to the optical disk is defined as Y and a highest recording linear velocity corresponding to the optical disk is defined as Z; and
a recording velocity is controlled so as to be the same as the recording velocity when the write once is not carried out, in a case where the recording velocity at the time of starting the write once is equal to or the less than X.

16. The optical disk recording and reading apparatus as claimed in claim 13,
wherein the recording velocity at the time of starting the write once is controlled so as to be the same recording velocity as a recording velocity when the write once is not carried out, in a case of S<R at a part where the write once is started wherein a distance in a radial direction from a position where the recording is started at the internal circumferential part of the optical disk to a position where the write once is started is defined as S, a distance from a most internal circumferential recording starting position to a most external circumferential recording completion position is defined as T, and R being constant has a value less than T/2.
